(19) United States
(12) Patent Application Publication
(10) Pub. No.: US 2013/0022817 A1
(43) Pub. Date: Jan. 24, 2013

(54) APPARATUS AND METHOD FOR TREATING SUBSTRATES TO RESIST GREASE AND OIL PENETRATION AND TREATED ARTICLES THEREFROM

(71) Applicants: Edwin A. Neal, Scottsdale, AZ (US); Daniel H. Bliss, Troy, MI (US); Rufus Dixon, Carrollton, GA (US); Thomas Galbierz, Brentwood, TN (US)

(72) Inventors: Edwin A. Neal, Scottsdale, AZ (US); Daniel H. Bliss, Troy, MI (US); Rufus Dixon, Carrollton, GA (US); Thomas Galbierz, Brentwood, TN (US)

(21) Appl. No.: 13/552,863

(22) Filed: Jul. 19, 2012

Related U.S. Application Data
(60) Provisional application No. 61/509,303, filed on Jul. 19, 2011.

(51) Int. Cl. B05D 1/36; B05D 1/38; B32B 33/00; B05C 13/00

(52) U.S. Cl. 428/411.1; 118/500; 118/58; 118/66; 427/402; 427/387; 427/258; 427/209

(57) ABSTRACT

An apparatus and method for treating a substrate to provide grease and oil resistance the substrate. The apparatus and method includes, applying a first film layer of a non-fluoro grease and oil resistant chemical on the surface of the substrate to form a first film layer on the surface of the substrate. The apparatus also includes applying a second film layer of a water resistant chemical over the first film layer to prevent the first layer from being contacted by water and to hold the first layer to the surface of the substrate.

### CROSS-REFERENCE TO RELATED APPLICATION(S)

The present application claims the priority date of co-pending U.S. Provisional Patent Application Ser. No. 61/509,303, filed Jul. 19, 2011.

### BACKGROUND OF THE INVENTION

1. Field of the Invention

The present invention relates generally to treating and treated substrates and, more particularly, to an apparatus and method for treating substrates to resist grease and oil penetration and treated articles therefrom.

2. Description of the Related Art

It is known to treat cellulose-containing materials such as paper, paper products, etc., to provide grease hold-out or function as a barrier to grease and oil penetration. “Grease hold-out” refers to the ability of the paper to resist penetration and/or leakage of grease and oil. This property can be measured by determining how long it takes a hydrocarbon solvent, such as turpentine, to leak through the paper or paper product. This property can also be: measured through a crease test that measures the amount of a dyed oil that leaks through the paper or paper product over a period of time,

In order to provide oil and grease holdout, or enhanced resistance to oil and grease penetration, the web of fibers can be treated with a fluorochemical. When fluorochemicals are applied to the surface of a web of fibers, they can render the surface oleophobic such that the surface repels oil and resists oil penetration. Accordingly, after the surface of the web has been treated fluorochemically, oil generally tends to bead up on the surface. Exemplary fluorochemicals that can be used include those known in the industry that can be referred to as paper fluorochemicals, paper fluoro-protectants, or perfluorinated surfactants. One example of a suitable fluorochemical is LODYNE® P-208E, which is available from Ciba Specialty chemicals. Other suitable fluorochemicals include ZONYL® 9464 available from Dupont, Wilmington, Del., and FLUOROLINK® available from Ausimont USA, Thorofare, N.J.

An example of treating a paper product with a fluorochemical to provide grease and oil resistance is disclosed in U.S. Pat. No. 7,642,490 to Trochlil. In this patent, a fluorochemical is used to treat a single ply paper product. The phrase “single ply” refers to the existence of a continuous single web of fibers that is not laminated to another continuous web of fibers. In some embodiments, both sides of the paper product are treated with fluorochemicals that penetrate throughout the interior of the paper and cause the web of fibers to have enhanced grease holdout.

Resistance to oil and grease penetration can also be enhanced by applying a film layer on the web of fibers. By way of example, a film layer may be applied to discrete areas of the paper that may be folded or creased when a bag is formed.

Cellulosic substrates such as paper and cardboard (e.g., including corrugated fiberboard, paperboard, display board, or card stock) products may encounter substances such as grease and oil under various environmental conditions based on their intended use. For example, cardboard is often used as packaging material for shipping and/or storing products and must provide a durable enclosure that protects its contents. Other products include disposable food service articles, which are commonly made from paper or paperboard. These cellulosic substrates also face moist environmental conditions, e.g., vapors and liquids from the foods and beverages they come in contact with.

More particularly, the use of fluorochemicals, such as fluorocarbons, heretofore have been utilized in most if not all equivalent commercially-available oil and grease resistant coatings. Some fluorocarbons are no longer desirable for use in coatings such as those used in providing oil and grease resistance on paper packaging, including food wrappers, food containers and the like, as they have recently been found to have deleterious effects on the environment and possibly on human health.

Therefore, it is desirable to provide an apparatus and method for treating substrates with a non-fluorochemical to resist grease and oil penetration and a treated article therefrom. It is also desirable to provide an apparatus and method that treats paper with a non-fluorochemical to resist grease and oil penetration and a treated article therefrom. It is further desirable to provide an apparatus and method that treats cellulosic substrates with a non-fluorochemical that allows the treated substrate to be recycled, repulped, and biodegradable after treatment with the non-fluorochemical. Therefore, there is a need in the art to provide an article, apparatus, and method that meets at least one of these desires.

### SUMMARY OF THE INVENTION

It is, therefore, one object of the present invention to provide a new apparatus and method for treating substrates to provide grease and oil holdout and treated articles therefrom.

It is another object of the present invention to provide a new apparatus and method for treating cellulosic substrates with a non-fluorochemical to provide grease and oil holdout and treated articles therefrom.

To achieve the foregoing objects, the present invention is an apparatus and method for treating a substrate to provide grease and oil holdout to the substrate. The apparatus and method includes applying a first film layer of a non-fluoro grease and oil resistant chemical on the surface of the substrate to form a first film layer on the surface of the substrate. The apparatus also includes applying a second film layer of a water resistant chemical over the first film layer to prevent the first layer from being contacted by water and to hold the first layer to the surface of the substrate.

The present invention is also a treated article having grease and oil holdout. The treated article includes a substrate having at least one surface and a first film layer of a non-fluoro grease and oil resistant chemical on the at least one surface of the substrate. The treated article also includes a second film layer of a water resistant chemical over the first film layer to prevent the first layer from being contacted by water and to hold the first layer to the surface of the substrate.

One advantage of the present invention is that an apparatus and method is provided for treating substrates with a non-fluorochemical to provide grease and oil holdout for a treated article. Another advantage of the present invention is that the apparatus and method treats cellulosic substrates such as paper with a non-fluorochemical to provide resistance to grease and oil penetration. An additional advantage of the present invention is that the apparatus and method treats cellulosic substrates such as paper with a non-flurochemical that makes the treated paper recyclable, repulpable, and biodegradable after treatment with the non-fluorochemical. Still another advantage of the present invention is that the apparatus and method treats various cellulosic substrates such as paper with a non-fluorochemical and a water resistant chemical to prevent the non-fluorochemical from leaving the surface of the substrate when in contact with water. A further advantage of the present invention is that the apparatus and method treats various cellulosic substrates with non-fluorochemicals and water resistant chemicals and is relatively inexpensive. Yet a further advantage of the present invention is that the apparatus and method treats various cellulosic substrates with non-fluorochemicals and water resistant chemicals that are relatively easy to apply. Still a further advantage of the present invention is that the apparatus and method treats various cellulosic substrates with non-fluorochemicals and water resistant chemicals that have relatively short treatment time.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a schematic view of an apparatus, according to the present invention, for treating cellulosic substrates with non-fluorochemicals and water resistant chemicals.

### DESCRIPTION OF THE PREFERRED EMBODIMENT(S)

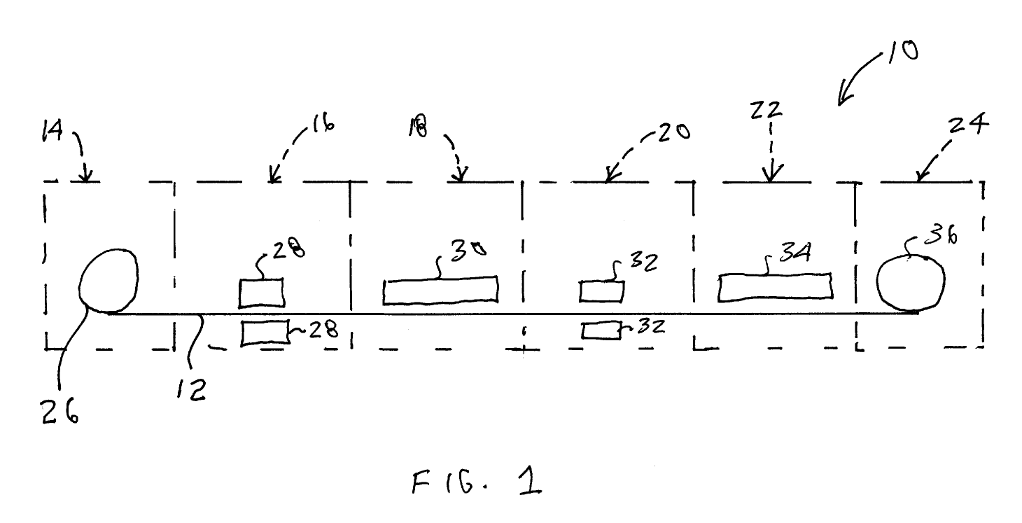

Referring to the drawings and in particular FIG. 1, one embodiment of an apparatus 10, according to the present invention, is shown for treating various substrates with non-fluoro grease and oil resistant chemicals and water resistant chemicals, according to the present invention. The term “treated” (and its variants such as “treating,” “treat,” “treats,” and “treatment”) means applying the non-fluoro grease and oil resistant chemical to the substrate to form a film on the substrate. The term “substrate” as used herein is meant to include any material or object that can be treated with the non-fluoro grease and oil resistant chemicals of the present invention, including, but not limited to, cellulose material (e.g., textiles, cotton, cloth, etc.), paper (e.g., cardboard, roofing paper, paper used to coat insulation, sheet rock paper, newsprint, paper towel, etc.). It should be appreciated that the substrate may be used in food applications such as the formation of bags or containers to hold various food products including: popcorn, French fries, pizza, frozen dinners, and many others. It should also be appreciated that the substrate may also be used in non-food applications where grease hold-out is a requirement, such as tubes for holding lubricating oils or greases. It should further be appreciated that the substrate may be used to form containers for holding metal parts that are shipped with grease pre-applied.

The substrates described herein may be biodegradable. For purposes of this application, the terms ‘compostable,’ and ‘compostability’ encompass factors such as biodegradability, disintegration, and ecotoxicity. The terms ‘biodegradable, ‘biodegradability,’ and variants thereof refer to the nature of the material to be broken down by microorganisms. Biodegradable means a substrate breaks down through the action of a microorganism, such as a bacterium, fungus, enzyme, and/or virus over a period of time. The term ‘disintegration,’ disintegrate,' and variants thereof refer to the extent to which the material breaks down and falls apart. Ecotoxicity testing determines whether the material after composting shows any inhibition on plant growth or the survival of soil or other fauna. Biodegradability and compostability may be measured by visually inspecting a substrate that has been exposed to a biological inoculum (such as a bacterium, fungus, enzyme, and/or virus) to monitor for degradation. In general, rate of compostability and/or biodegradability may be increased by maximizing surface area to volume ratio, of each substrate. For example, surface area/volume ratio may be at least 10, alternatively at least 17. In another embodiment, surface area/volume ratio may be at least 33. Without wishing to be bound by theory, it is thought that a surface area/volume ratio of at least 33 will allow the substrate to pass the test for biodegradability in ASTM Standard D6868-03.

All amounts, ratios, and percentages are by weight unless otherwise indicated. The articles ‘a’, ‘an’, and ‘the’ each refer to one or more, unless otherwise indicated by the context of specification. The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range. Furthermore, disclosure of a range of, for example, 2.0 to 4.0 includes the subsets of, for example, 2.1 to 3.5, 2.3 to 3.4, 2.6 to 3.7, and 3.8 to. 4.0, as well as any other subset subsumed in the range. Similarly, the disclosure of Markush groups, includes the entire group and also any individual members and subgroups subsumed therein. For example, disclosure of the Markush group: an alkyl group, a cycloalkyl group, an alkenyl group, an alkynyl group, or an aryl group; includes the member alkyl individually; the subgroup alkyl and aryl; and any other individual member and subgroup subsumed therein.

For purposes of this application, the term “non-fluoro grease and oil resistant chemical” means that no fluorochemical is present, or that less than 1% fluorochemical is present. (No fluorochemical is intentionally added; the 1% amount may be present as an impurity in the non-fluoro grease and oil resistant chemical from the production process used to make the non-fluoro grease and oil resistant chemical.)

For purposes of this application, the term “water resistant chemical” means a chemical that resists water. Water resistance is a property of the chemical such that the chemical does not react with or repels water.

For purposes of this application, the term “grease and oil hold-out” refers to the ability of the paper to resist penetration and/or leakage of grease and oil. When non-fluoro grease and oil resistant chemicals are applied to the surface of a web of fibers, they can render the surface oleophobic such that the surface repels oil and resists oil penetration. Accordingly, after the surface of the web has been treated for grease and oil holdout, oil generally tends to bead up on the surface.

The substrates treated by the apparatus described herein may also be inherently recyclable. The substrates may also be repulpable, e.g., the treated Substrate prepared and described herein may be reduced to pulp for use in making paper. The substrates may also be repurposeable.

In accordance with one embodiment of the present invention, the apparatus treats a substrate with a non-fluoro grease and oil resistant chemical to provide grease and oil holdout to the substrate. The apparatus includes an applicator for applying the non-fluoro grease and oil resistant chemical to a surface of a substrate to create a first film layer. The apparatus also includes an applicator for applying a water resistant chemical to the surface of the first film layer to create a second film layer to prevent the first film layer from being contacted by water and to hold the first film layer to the surface of the substrate to form a treated substrate.

The apparatus may be continuous, semi-batch, or cascading. When the apparatus is continuous, the substrate may be continuous. An example of a continuous substrate is a roll of paper. The paper may be supplied on a roll, unwound and passed through the sections described herein, and collected on an uptake roll. In the present invention, the substrate is exemplified by, but not limited to cellulosic substrates such as paper (such as cardboard, boxboard, medium, or liners used to make corrugated cardboard). The substrate may comprise a single, flat, substrate (such as a single flat piece of paper or paperboard) or may comprise a folded, assembled, or otherwise manufactured substrate. For example, the substrate can comprise multiple substrates glued, rolled, or woven together (such as a corrugated assembly including a medium and one or two liners on a surface of the medium or a box) or can comprise varying geometries. In the present invention, the substrate can be a subset component of a larger substrate such as when the substrate is combined with plastics, fabrics, non-woven materials, and/or glass. It should be appreciated that substrates may thereby embody a variety of different materials, shapes and configurations and should not be limited to the exemplary embodiments expressly listed herein. When the substrate is not continuous, the apparatus may be operated in a semi-batch mode, for example, by placing the substrates (e.g., planks or sheets or cardboard boxes) on a conveyor and passing the substrates through the sections described herein. When the apparatus is cascading, the substrate may be continuous or sheets passed through the sections and the chemicals are cascaded onto the substrate similar to a conventional wax coating process.

In the apparatus described herein, the substrate is treated with a non-fluoro grease and oil resistant chemical, alternatively a plurality of non-fluoro grease and oil resistant chemicals, alternatively a water resistant chemical, and alternatively, a plurality of water resistant chemicals. When a plurality of non-fluoro grease and oil resistant chemicals is used, the plurality of non-fluoro grease and oil resistant chemicals comprises at least a first non-fluoro grease and oil resistant chemical and a second non-fluoro grease and oil resistant chemical different from the first non-fluoro grease and oil resistant chemical. One such exemplary non-fluoro grease and oil resistant chemical is polyvinyl alcohol (PVOH, PVA, or PVAl). Polyvinyl alcohol is a water-soluble synthetic polymer (not to be confused with polyvinyl acetate, a popular wood glue). Polyvinyl alcohol has excellent film forming, emulsifying, and adhesive properties. It is resistant to oil, grease, and solvent. It is odorless and nontoxic. It has high tensile strength and flexibility, as well as high oxygen and aroma barrier properties. However these properties are dependent on humidity, in other words, with higher humidity more water is absorbed. The water, which acts as a plasticiser, will then reduce its tensile strength, but increase its elongation and tear strength. PVA is fully degradable and is a quick dissolver. PVA has a melting point of 230° C. and 180-190° C. (356-374 degrees Fahrenheit) for the fully hydrolysed and partially hydrolysed grades, respectively. It decomposes rapidly above 200° C. as it can undergo pyrolysis at high temperatures.

Another exemplary of a non-fluoro grease and oil resistant chemical is HOLDOUT™ from Celealus Holdings LLC. HOLDOUT™ is a water-based formulation containing zein that is used to impart oil and grease resistance to paper and paperboard. HOLDOUT™ is a non-toxic, biodegradable replacement for fluorinated compounds. These and other non-fluoro grease and oil resistant chemicals can be produced through methods known in the art or purchased from suppliers such as Dow Coming Corporation of Midland, Mich., USA, Kuraray (Japan and Europe), and Sekisui Specialty Chemicals, USA. Furthermore, while specific examples of non-fluoro grease and oil resistant chemicals are explicitly listed herein, the above-disclosed examples are not intended to be limiting in nature.

One such exemplary water resistant chemical is silicone such as a water based precured silicone elastomer. Another exemplary water resistant chemical is a silane such as a halosilane. These and other water resistant chemicals can be produced through methods known in the art or purchased from suppliers such as Dow Coming Corporation of Midland, Mich., USA, Momentive Performance Materials of Albany, N.Y., USA, or Gelest, Inc. of Morrisville, Pa., USA. Furthermore, while specific examples of water resistant chemicals are explicitly listed herein, the above-disclosed examples are not intended to be limiting in nature.

Referring to FIG. 1, one embodiment of an apparatus 10, according to the present invention, for treating a substrate 12 includes a feeding section 14, a first treatment section 16, a first drying section 18, a second treatment section, a second drying section 22, and a collecting section 24.

In the feeding section 14, the apparatus 10 includes a feeder 26 for feeding the substrate 12 to the first treatment section 16. In the embodiment illustrated, the substrate 12 to be treated is paper and the feeder 26 is an unwinder such as a backstand with a brake for a feed roll. The feed speed is controlled by a collector 36 such as a rewinder for an uptake roll to be described.

In the first treatment section 16, the apparatus includes at least one applicator 28 for applying the non-fluoro grease and oil resistant chemical to the substrate 12 to form a first film layer on the surface of the substrate 12. In one embodiment, the non-fluoro grease and oil resistant chemical is polyvinyl alcohol(PVA). In another embodiment, a film forming solution can be provided to the exterior of a given layer of paper to create a film. The film forming solution is a mixture of the non-fluoro grease and oil resistant chemical and a carrier. In one embodiment, the carrier is water. The film forming solution is made with a larger percentage of the carrier than the non-fluoro grease and oil resistant chemical. In one embodiment, the carrier ranges from approximately eighty percent to approximately ninety percent and the non-fluoro grease and oil resistant chemical ranges from approximately ten percent to approximately twenty percent. The apparatus 10 may includes a pump (not shown) to pump the film forming solution from a tank (not shown) to the applicator 28. In one embodiment, the applicator is of a rod type to apply a liquid solution to the substrate 12. It should be appreciated that the liquid may be applied to the substrate 12 by any convenient applicator such as a gravure, blade, or air knife. It should also be appreciated that the first treatment section 16 may include one or more rollers (not shown) for directing the substrate 12 through the section.

In the first drying section 18, the apparatus 10 includes at least one, preferably a plurality of dryers 30 to dry the first film layer so that it is not tacky. In one embodiment, the dryers 30 are heaters to apply infrared heat to the substrate 12. In another embodiment, the dryers are air bars or air knives (not shown) to remove moisture from the first film layer with air from a source (not shown). It should also be appreciated that the drying section 18 may include one or more rollers (not shown) for directing the treated substrate 12 through the section.

In the second treatment section 20, the apparatus 10 may include at least one applicator 32 for applying a water resistant chemical to the first film layer to form a second film layer over the first film layer. The second film layer prevents the first layer from being contacted by water and to hold the first layer to the surface of the substrate 12. In one embodiment, the water resistant chemical is a silicone such as a water based precured silicone elastomer. In another embodiment, the water resistant chemical is a silane such as a halosilane. The apparatus 10 may includes a pump (not shown) to pump the water resistant chemical from a tank (not shown) to the applicator 32. In one embodiment, the applicator 32 is of a rod type to apply a liquid water resistant chemical to the first film layer. It should be appreciated that the liquid may be applied to the first film layer by any convenient applicator such as a gravure, blade, or air knife. It should also be appreciated that the second treatment section 20 may include one or more rollers (not shown) for directing the treated substrate 12 through the section.

In the second drying section 22, the apparatus 10 includes at least one, preferably a plurality of dryers 34 to dry the second film layer so that it is not tacky. In one embodiment, the dryers 34 are heaters to apply infrared heat to the second film layer. In another embodiment, the dryers 34 are air bars or air knives (not shown) to remove moisture from the second film layer with air from a source (not shown). It should be appreciated that the drying section 22 may include one or more rollers (not shown) for directing the treated substrate 12 through the section. It should also be appreciated that, after the second drying section 22, the treated substrate 12 is collected in the collecting section 24, tested, and prepared for shipment to the customer.

In the collecting section 24, the apparatus 10 includes a collector 36 to collect the treated substrate 12. In one embodiment, the collector 36 is a rewinder. The collector 36 may be connected to a controller (not shown) for controlling the feed rate. It should be appreciated that the treated substrate 12 is removed from the collector 36 and tested, and prepared for shipment to the customer.

The treated substrate 12 is a treated article having grease and oil holdout. The treated article includes the substrate 12 having at least one surface and a first film layer of a non-fluoro grease and oil resistant chemical on the at least one surface of the substrate 12. The treated article also includes a second film layer of a water resistant chemical over the first film layer to prevent the first layer from being contacted by water and to hold the first layer to the surface of the substrate 12.

In another embodiment of the present invention, the substrate 12 may be eliminated. In this embodiment, the first film layer acts as the substrate having grease and oil holdout. The treated article includes a first film layer of a non-fluoro grease and oil resistant chemical to form a substrate having at least one side. The treated article also includes a second film layer of a water resistant chemical over the at least one side of the first film layer or substrate to prevent the first layer from being contacted by water. It should be appreciated that, in this embodiment, the treated article may be used as an agricultural film or in flexible packaging including pouches, wraps, single-wall bags, multi-wall bags, rollstock, lidding, etc.

In operation of the apparatus 10, the substrate may be fed at a rate of approximately 500 feet per minute. The rod type applicator applies the first film layer with thickness ranging from approximately 0.5 millimeters to approximately 3.0 millimeters. The first film layer is then dried for a time period ranging from approximately 1 second to approximately 5 seconds. Since the non-fluoro grease and oil resistant chemical used to form the first film layer is water soluble, a water resistant chemical is applied to form a second film layer over the first film layer. The second film layer has a thickness ranging from approximately 0.5 millimeters to approximately 3.0 millimeters. The second film layer is dried for a time period ranging from approximately 1 second to approximately 5 seconds. The thickness of the layers and the drying time Will vary depending on desired process outcomes. For example, the treatment parameters may be selected such that the total thickness of the layers ranges from approximately 0.5 millimeters to approximately 3.0 millimeters and drying time inside the sections ranges from 1 second to 5 seconds. The feed rate of the substrate may be controlled using various computer control schemes. For example, the feed rate may be adjusted based upon speed, width, and thickness of the substrate being treated. In one embodiment, the feed rate of the substrate may be adjusted based upon amount of non-fluoro grease and oil resistant chemical applied to the substrate. In another embodiment, the feed rate of the substrate may be adjusted based on a calculated amount of thickness of the non-fluoro grease and oil resistant chemical imparted to the substrate. The exact temperature selected depends on various factors including the degradation temperature of the substrate and the reactivity of the chemicals selected. In one embodiment, the temperature of the substrate entering the treatment section may range from 60° F. to 120° F. (16° C. to 49° C.).

To increase the rate of reaction, the substrate can also optionally be heated and/or dried with air, after the chemicals are applied to the substrate. For example, the substrate can pass through a drying section zone in which heat is applied to the substrate. The temperature of the heat will depend on the type of substrate and its residence time therein; however, the temperature in the drying section may comprise a temperature in excess of 200° F. In one embodiment, the temperature can vary depending on the factors including the type of substrate, the speed in which the substrate passes through the drying section, the thickness of the substrate, and/or the amount of the chemicals applied to the substrate. In one embodiment, the temperature provided to the substrate may be sufficient to heat the substrate to 200° F. upon its exit from the drying section. In another embodiment, the temperature provided may be sufficient to heat the substrate to 100° C., alternatively 80° C., and alternatively 65° C. upon its exit from the drying section.

In the present invention, the film is applied as a continuous film over the entire surface of the web of fibers. In another embodiment, the film is applied in discrete areas of the paper product. In yet another embodiment, the film is applied to one surface of the substrate. In a further embodiment, the film is applied to both sides of the substrate. In still another embodiment, the first and second films are applied in one pass of the substrate 12 through the apparatus 10. In still a further embodiment, the first film is applied in one pass of the substrate 12 through the apparatus 10 and the second film is applied in a second pass of the substrate 12 through the apparatus 10.

In another embodiment, a film forming solution can be provided to the exterior of a given layer of paper to create a film. The film should be appropriate for contact with food, adhere to the paper sufficiently under the conditions of use, and adhere to the laminating adhesive under conditions of use. Many types of film forming solutions are contemplated by the present invention. Suitable film forming solutions can include oxidized starches (corn, wheat, potato, tapioca, etc.), ethylated starches, cationic starches, unmodified starches, starch based adhesives, proteins, synthetic resins, polyvinyl acrylates, polyvinyl acetate, polyvinyl alcohol, polyvinylalcohol based adhesives, vinyl acetate acrylic, styrene acrylates, vinyl acetate, ethylene vinyl acetate, styrene maleic anhydride as well as viscosity modifiers such as sodium alginate, sodium carboxymethyl cellulose, hydroxylethyl cellulose, poly sodium acrylate, guar gum, gum arabic, xanthan gum, or combinations thereof. By way of further example, ethylated starch is available from Penford Products Co., 1001 First Street S.W., Cedar Rapids, Iowa 52404.

Though the film can be made from components that can act as adhesives in other contexts, when used to create a film, these components are not functioning as adhesives because they are not being used primarily to adhere one component to another.

In another embodiment of the invention, the film forming solution is a combination of starch and alginate. The combination of starch and alginate is known to be compatible with food and can also be printed on. Alginate is a natural polysaccharide produced from seaweed, which is soluble in cold or hot water. Starch and alginate are both commercially available. One type of alginate used is sodium alginate sold as SNP S-500-C and is available from Synthetic Natural Polymers (SNP), PO Box 11575, Durham, N.C. 27703.

Once the substrate is treated, the treated substrate will have grease and oil holdout, water resistance, and gas transmission or permeability barrier resulting from the chemicals forming films on the substrate as discussed above. One of skill in the art will appreciate that the ability of a paper product to provide grease holdout can be tested in many ways. For example, a standard procedure for this test is described by the TAPPI turpentine test for voids in glassine and greaseproof papers (TAPPI test T 454 om-94). The results of this test are measured in terms of how many minutes it takes before any turpentine starts to show through the paper product. In an embodiment of the invention, the paper product resists turpentine showing through the paper product for greater than 2 hours. The ability of a paper product to function as a grease barrier specifically for food content paper can also be tested in various ways. One test is to place droplets of oil on the paper product. The results of this test are measured by how long it takes before oil passes through the paper product. Another test would be to place an oily food in the paper product. The results of this test are measured by how long it takes before oil passes through the paper product.

The present invention has been described in an illustrative manner. It is to be understood that the terminology, which has been used, is intended to be in the nature of words of description rather than of limitation.

Many modifications and variations of the present invention are possible in light of the above teachings. Therefore, the present invention may be practiced other than as specifically described.

What is claimed is:

1. An apparatus for treating a substrate to provide grease and oil holdout to the substrate comprising:
a first treatment section for applying a first film layer of a non-fluoro grease and oil resistant chemical on the surface of the substrate to form a first film layer on the surface of the substrate; and
a second treatment section for applying a second film layer of a water resistant chemical comprising silicone over the first film layer to prevent the first layer from being contacted by water and to hold the first layer to the surface of the substrate.

2. An apparatus as set forth in claim 1 including a feeding section for feeding the substrate to the first treatment section.

3. An apparatus as set forth in claim 2 including a first drying section for drying the treated substrate from the first treatment section.

4. An apparatus as set forth in claim 3 including a second drying section for drying the treated substrate from the second treatment section.

5. An apparatus as set forth in claim 4 including a collecting section for collecting the dried treated substrate from the second drying section.

6. A method for treating a substrate to provide grease and oil holdout to the substrate comprising:
applying a first film layer of a non-fluoro grease and oil resistant chemical on the surface of the substrate to form a first film layer on the surface of the substrate; and
applying a second film layer of a water resistant chemical comprising silicone over the first film layer to prevent the first layer from being contacted by water and to hold the first layer to the surface of the substrate.

7. A method as set forth in claim 6 wherein the step of applying the first film layer comprises applying the first film layer with a thickness ranging from approximately 0.5 millimeters to approximately 3.0 millimeters.

8. A method as set forth in claim 6 including the step of drying the applied first film layer.

9. A method as set forth in claim 8 wherein the step of drying comprises drying the first film layer for a time period ranging from approximately 1 second to approximately 5 seconds.

10. A method as set forth in claim 6 wherein the step of applying the second film layer comprises applying the second film layer with a thickness ranging from approximately 0.5 millimeters to approximately 3.0 millimeters.

11. A method as set forth in claim 6 including the step of drying the applied second film layer.

12. A method as set forth in claim 11 wherein the step of drying comprises drying the second film layer for a time period ranging from approximately 1 second to approximately 5 seconds.

13. A method as set forth in claim 6 including the step of applying the film as a continuous film over the entire surface of the web of fibers.

14. A method as set forth in claim 6 including the step of applying the film in discrete areas of the substrate.

15. A method as set forth in claim 6 including the step of applying the first film layer to only one surface of the substrate.

16. A method as set forth in claim 6 including the step of applying the first film layer to both sides of the substrate.

17. A method as set forth in claim 6 including the step of applying the first and second film layers in one pass of the substrate through an apparatus.

18. A method as set forth in claim 6 including the step of applying the first film layer in one pass of the substrate through an apparatus and the second film layer is applied in a second pass of the substrate through an apparatus.

19. A treated article having grease and oil holdout comprising:
a substrate having at least one surface;
a first film layer of a non-fluoro grease and oil resistant chemical on the at least one surface of the substrate; and
a second film layer of a water resistant chemical over the first film layer to prevent the first layer from being contacted by water and to hold the first layer to the surface of the substrate.
